(19) United States
(12) Patent Application Publication
(10) Pub. No.: US 2005/0153034 A1
(43) Pub. Date: Jul. 14, 2005

(54) Antimicrobial yarn in knitted fabric for processing of meat

(76) Inventor: Andrew E. Bylenga, Greenville, SC (US)

Correspondence Address: John B. Hardaway, III;NEXSEN PRUET, LLC, P.O. Box 10107, Greenville, SC, 29603, US

(21) Appl. No.: 10/991,959

(22) Filed: Nov. 18, 2004

Related U.S. Application Data
(60) Provisional application No. 60/523,509, filed on Nov. 19, 2003.

(51) Int. Cl. A23B 4/00; B32B 1/08; D04B 9/42; B29D 22/00

(52) U.S. Cl. 426/392; 428/34.8; 428/34.1; 426/665

(57) ABSTRACT

A casing structure for the treatment of foodstuffs, especially processed meats which are treated to have bactericidal or bacteriostatic properties. The treated netting is particularly applied to the control of Listeria monocytogenes on packaged meats during processing, shipment and storage.

### FIELD OF THE INVENTION

This invention relates generally to a casing structure, and more particularly to a net-like casing that acts to provide a protective halo from bacterial and microbial contamination during the processing and shipment of food products.

### BACKGROUND AND PRIOR ART

The act of packaging food products, especially meat based products in tubular knitting, is well developed and U.S. Pat. Nos. 5,413,148 and 5,885,231 are representative of netting arrangements with and without a casing in which the meat product may be stuffed. It has been, and continues to be, desirable to expose the material containing meat to various heating, chilling, and flavoring conditions to enhance and preserve the life of meat products.

During processing, and afterwards, these meat products and materials are exposed to bacteria detrimental to the preservation of meat.

Some bacteria also pose a health threat to consumers. Of particular concern is Listeria monocytogenes which may be found occasionally in ready-to-eat products, many of which are sold in casings or netting. Casings and nettings which include a residual bactericide or bacteriostat would be useful to safeguard the quality and safety of the meat product. The applicable regulations at this time are Section 201(q)(B)(i) of the Federal Food Drug and Cosmetic Act, as amended by the Antimicrobial Regulation Technical Corrections Act of 1998, which attempted to clarify the boundaries of authority of the FDA and EPA with respect to regulation of pesticides. As interpreted by the FDA Office of Food Additive Safety in July 1999: “All uses of antimicrobials in or on food packaging are food additive uses” and are regulated by FDA, not EPA. Similar regulatory schemes apply in most developed countries. As a food additive, the antimicrobial must be approved for addition to the food product, as opposed to a pesticide residue as established by EPA.

At the present time, among the approved antimicrobials are sodium and potassium lactate, buffered sodium citrate, acidified calcium sulfate, certain extracts from spices, nisin (U.S. Pat. Nos. 5,451,369 and 5,573,801), sodium benzoate, sodium propionate, and potassium sorbate, all of which have some water solubility and are leachable from any package.

The existence of antimicrobial yarns is well known, but not for food use. U.S. Pat. No. 5,104,649 is directed to derivatized polymers for permanently fixing antimicrobials to polymers.

U.S. Patent Publication No. 2002 0051754A1 discloses a method for covalently linking a quat salt to a polymer backbone.

U.S. Patent Publication No. 2002 012742A1 applies silver as part of a dye to a yarn to fix the silver to the fabric.

U.S. Patent Publication No. 2001 0049017A1 applies triclosan to an acetate fiber that is then woven or knitted with another fiber for greater strength.

Because of the small number of antimicrobials approved as food grade materials, the majority of antimicrobial fabrics are used in clothing, diapers, wash clothes and mops.

Accordingly, there exists room for improvement within the art of preserving meat with a tubular netted material providing an antimicrobial protective halo for bacterial and microbial contamination.

### SUMMARY OF THE INVENTION

It is thus the object of this invention to provide a novel antimicrobial casing apparatus and use of the same that can be flexible or rigid and that can be used in a variety of diverse applications.

It is further the object of this invention to provide an antimicrobial packaging apparatus and process for producing and using the same that is ideally suited for the packaging of raw meats, and more particularly for the preparation of pre-cooked food products.

It is further the object of the invention to provide an antimicrobial casing structure and process of producing and using the same for processing of meat in which the yarn comprising the netted fabric can be permeated with antimicrobial agents, which are either leachable or permanently incorporated into the yarn.

It is further the object of the invention to provide an antimicrobial casing structure and process for producing and using the same which is easily interfaced with a horn of a meat packaging machine

It is further the object of the invention to provide an antimicrobial packaging apparatus and process for producing and using the same which can come in a variety of tubular shapes and netted patterns.

It is further the object of the invention to provide an antimicrobial casing structure and process for producing and using same which can alternately be used to protect items placed therein from bacterial and microbial contamination.

These as well as other objects are accomplished by an antimicrobial packaging apparatus comprising a tubular netted material providing knitted fabric composed of yarn including FDA approved antimicrobial agents.

### DETAILED DESCRIPTION OF THE INVENTION

In accordance with the invention, it has been found that an antimicrobial package apparatus and process for producing and using the same can be provided which, although packaging a variety of products such as meat, poultry and other soft products, has many other divergent uses and constructions.

The invention may be used with any conventional fiber netting including cotton, polyester, polyethylene, polypropylene, polyamides, and other staple fibers. An antimicrobial agent including bactericides and bacteriostats may be included in the fibers as manufactured, attached to the surface by a linker, or included in a dye or coating, or dried onto the fabric after dipping, or spraying other conventional coating methods. The only limitation is that the treatment must not impair the taste and coloration effects of liquid smoke and other processing steps.

The method is applicable to the food additives antimicrobials listed above which are currently approved, as well as antimicrobials that may be added at a future date. The antimicrobials may be at least partially water soluble so that the active antimicrobial agent can migrate to be effective over the whole surface of the product and also within the surface layer, or may be a part of the fiber of the net through incorporation into, or attachment to, the fiber and not leachable. The most preferred antimicrobial agents are those with a demonstrated effectively against L. monocytogenes as demonstrated by a zone of inhibition around a treated fabric on an inoculated agar plate.

Cooked meat which has been heated to at least 150° F. is presumed free of pathogenic bacteria. Additional protection may be obtained from certain artificial smokes, but the surface is not protected after surface temperatures drop back down below 150°, especially if wetted before used. The use of a netting which prevents or inhibits bacterial growth is desirable. The use of fibers in the net that have a bacteriastatic effect, such as the availability of a bacteriastatic agent such as a silver compound, inhibits the formation of bacterial growths. The silver compound may be attached chemically to the surface or incorporated in the polymer “dope” prior to extrusion or spinning. A preferred compound for this purpose is Alpha San® RC, CAS Number 265 647-11-8, a product of Milliken Chemical Company.

The amount of antimicrobial agent used depends upon the agent's activity versus L. monocytogenes, the fabric used, the method of inclusion, and applicable governmental regulations at the time of usage.

Although these are the primary advantages of the present invention, many other advantages and features will become apparent to those skilled in the art from a reading of the following description given with reference to the various figures and drawings.

While the packaging apparatus according to this invention is particularly suited for use in packaging and processing of food products, it is further envisioned that the antimicrobial packaging apparatus has applications in packaging other products, or for clothing items, especially hair nets for workers in food processing plants and the food service industry. Non-food uses include use in casting broken limbs and sanitary clothing for incontinent persons.

It is seen that the invention provides a novel antimicrobial packaging apparatus and process for producing the same. It is further seen that the invention provides an antimicrobial packaging apparatus and process for producing and using the same that can be flexible or rigid and can be used in a variety of applications. It is still further seen that the invention provides an antimicrobial packaging apparatus and process of producing and using the same that is ideally suited for antimicrobial packaging of raw and cooked meats. It is still further seen that the invention provides an antimicrobial packaging apparatus and process of producing and using the same for antimicrobial packaging apparatus and process for producing and using the same which is easily interfaced with a horn of a meat packaging machine.

It is still further seen that the invention provides an antimicrobial packaging apparatus and process for producing and using the same which can come in a variety of generally tubular shapes and patterns. It is still further seen that the invention provides an antimicrobial packaging apparatus and process for producing and using the same which can alternatively be used to protect foods placed therein from premature spoilage. Many variations are apparent to those skilled in the art, and such variations are embodied within the spirit of the present invention as measured by the following append claims.

1. A process for producing an antimicrobial packaging apparatus comprising the steps of:
providing an antimicrobial knitted yarn tubular material having at least one open end and defining a hollow space therein;
placing an antimicrobial yarn knitted tubular material on a stuffing horn so as to surround the product with the net whereby the net material is positioned substantially around the product protecting it from microbes;
closing at least one end of the antimicrobial yarn knitted tubular material to totally encapsulate the product during processing;
wherein said antimicrobial yarn knitted tubular material is liquid permeable and suitable to absorb liquid smoke and agents to color and is effectively released from cooked surfaces.

2. A process according to claim 1 wherein said antimicrobial yarn is selected from the group consisting of cotton, polyester polyethylene, polypropylene, polyamides, and mixtures thereof.

3. A process according to claim 1 wherein said antimicrobial yarn contains a food grade additive approved by the U.S. Food and Drug Administration.

4. A process according to claim 1 wherein said antimicrobial yarn has an antimicrobial agent included in the yarn as spun or extruded.

5. A process according to claim 1 wherein said antimicrobial yarn has an antimicrobial agent applied to the surface of the yarn.
